(19) United States
(12) Patent Application Publication
(10) Pub. No.: US 2006/0200759 A1
(43) Pub. Date: Sep. 7, 2006

(54) Techniques for generating the layout of visual content

(75) Inventors: Maneesh Agrawala, Seattle, WA (US); Adam Clyde Eversole, Redmond, WA (US); Daniel John Vogel, Toronto (CA); Charles E. Jacobs, Seattle, WA (US); David H. Salesin, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/072,747

(22) Filed: Mar. 4, 2005

(51) Int. Cl. G06F 17/00

(52) U.S. Cl. 715/517

(57) ABSTRACT

Systems and methods comprising a general purpose framework to facilitate automated layout are provided. Such systems and methods can be utilized to automatically generate visual content over a wide range of domains. One example of a framework comprises a set of general purpose layout components adjustable to a plurality of domains. The general purpose layout components facilitate the automated arrangement of visual elements according to a plurality of style rules. One example of a method performed utilizing one or more elements of a general purpose adaptable layout framework comprises quantifying at least one aesthetic quality of a depiction in relation to one or more non-mandatory objectives to produce a quantified aesthetic quality, and automatically optimizing the quantified aesthetic quality to produce an enhanced depiction.

### TECHNICAL FIELD

The system and methods described herein generally relate to layout techniques, and more particularly to techniques for automatically generating the layout of visual content.

### BACKGROUND OF THE INVENTION

Manually laying out visual content is labor-intensive and time-consuming. To address this issue, techniques to automatically arrange the visual elements of an image have been developed. However, these techniques have focused on incorporating a few low-level functional principles centered on a small number of elements and have ignored high-level aesthetic considerations. Thus, the layouts produced by these methods may be clear and readable, but generic and lacking in aesthetic quality. The focus on functional principles to automate visual layout suggests how difficult it is to automatically analyze and generate aesthetically effective layouts.

Moreover, because many applications require the ability to automatically layout a set of visual objects while maintaining a set of application-dependent design constraints, developers must rewrite automated layout algorithms for each such application. For example, map design applications must place text labels on the underlying map while ensuring that the labels do not cover any important features of the map (i.e. roads, rivers, cities, etc.) and that the labels do not overlap one another. Similarly, automated layout is an essential feature of graph and chart design applications, ink annotation software, digital publishing applications and business presentation software, all of which have their own application-specific requirements.

Given the limitations of application-specific automated layout techniques and the aesthetically-lacking quality of the generated images, there is a strong need for systems and methods to automatically incorporate rich, aesthetic principles into the layout of visual information across a wide range of scenarios.

### SUMMARY OF THE INVENTION

This summary does not provide an extensive overview of the invention. Its sole purpose is to present some concepts in a simplified form as a prelude to the more detailed description that is presented later.

Current automated layout systems only apply a small number of application-specific functional principles to a small number of visual elements to generate visual content. Consequently, the images produced can be aesthetically-bland and the algorithms used do not transfer to other applications. The systems and methods described herein overcome these limitations by providing a general purpose framework for automatically laying out visual content with rich and diverse aesthetic qualities.

One way these results may be achieved is by providing a framework that abstracts low-level algorithms into a general purpose layout API applicable to a range of domains. The framework makes it much easier for developers to produce an automated layout subsystem for any application. The framework allows developers (and designers) to quickly specify their domain-specific requirements and to quickly generate aesthetically-pleasing layouts of the visual objects while respecting the domain specific constraints. These results also may be achieved by expanding the number and diversity of objectives and visual elements operated on.

One method of automatically enhancing a depiction comprises quantifying at least one aesthetic quality of the depiction in relation to one or more non-mandatory objectives to produce a quantified aesthetic quality. The method further comprises automatically optimizing the quantified aesthetic quality to produce an enhanced depiction, wherein automatically optimizing the quantified aesthetic quality is performed utilizing one or more elements of a general purpose adaptable layout framework. The quantified aesthetic quality may be automatically optimized utilizing simulated annealing techniques. The simulated annealing techniques may be implemented to accept all good moves and accept some bad moves according to a probability. Automatically optimizing the quantified aesthetic quality may be implemented to avoid local minima. The general purpose adaptable layout framework may be a general purpose layout API.

The one or more non-mandatory objectives may relate to one or more objectives such as linear alignment, translational alignment, angular alignment, full alignment, frames of reference, distribution, balance, proportion, color contrast, continuity, text wrapping, justification, text style, line style, labels, themes and Gestalt principles. The depiction may be characterized by one or more visual elements. The visual elements may relate to one or more elements such as a circle, a pie slice, a single line, an axis aligned text element, a multi-line text element with justification support, multiple line segments, polygons, a callout, an axis aligned rectangle, an element defining the fixed side of a callout, and an element allowing snapping behavior when exact alignment at a particular location is desirable.

Depictions produced according to the method also are contemplated as are computer-executable instructions for performing the method and signals carrying computer-executable instructions for performing the method to be transmitted on a network.

A method for improving an image also is provided. The method comprises invoking means for perturbing and means for scoring. The means for perturbing perturbs one or more elements of a layout of the image to produce a current layout in accordance with one or more hard constraints. The means for scoring assigns a score to the current layout. The score reflects adherence to one or more soft constraints. The current layout is accepted if the score indicates improvement in adherence to the one or more soft constraints. The method further comprises reinvoking the means for perturbing and the means for scoring to operate on the current layout if the score does not indicate improvement and if a termination condition has not been satisfied. The method is terminated if the termination condition has been satisfied. The method may be implemented by one or more layout APIs.

A system for identifying a desired arrangement of visual elements also is provided. The system comprises a set of general purpose layout components providing a framework for facilitating the automated arrangement of the visual elements according to a plurality of style rules. The general purpose layout components are adjustable to a plurality of domains. The system may be configured so that at least one style rule is a universal design criteria and/or at least one style rule is derived from Gestalt principles and/or at least one style rule is specified by a user. The set of general purpose layout components may be a set of general purpose layout APIs.

The plurality of style rules may relate to one or more of linear alignment, translational alignment, angular alignment, full alignment, frames of reference, distribution, balance, proportion, color contrast, continuity, text wrapping, justification, text style, line style, labels, themes and Gestalt principles. The components may be distributed across a network. Visual content produced by the system also is contemplated.

The following description and the annexed drawings set forth in detail certain illustrative aspects of the invention. These aspects are indicative, however, of but a few of the various ways in which the principles of the invention may be employed and the invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates one aspect of an exemplary general purpose framework for enhancing visual content.

FIG. 2 illustrates an exemplary method of employing a general purpose adjustable layout framework.

FIG. 3 illustrates an exemplary system that enhances a layout utilizing the components of a layout framework adaptable to a plurality of applications.

FIG. 4 illustrates an exemplary layout tree.

FIG. 5 illustrates an exemplary pointer array for holding dependency information.

FIG. 6 is a schematic diagram of an exemplary computing environment.

### DESCRIPTION OF THE INVENTION

The system and methods described herein provide a general purpose framework relating to automated layout techniques for enhancing the visual qualities of a layout. Suitable general purpose frameworks include an Application Program Interface (API), for example. The framework may be utilized, for example, to facilitate laying out maps, GIS data, CAD drawings, e-commerce catalogues, virtual reality environments, gardens, modular furniture, user interfaces, graph and chart design applications, ink annotation software, digital publishing applications and business presentation software.

The framework is useful for functionally and aesthetically enhancing a layout. The framework may be used to allow applications developers and/or users to express design constraints at a high level, thereby facilitating faster development and testing and reducing or even eliminating manual tasks (e.g., specification of label positions, forcing text to fit a particular space, etc.). By way of example, the framework may be used to apply functional rules that make the meanings and associations of elements in a layout clear and unambiguous. The framework may include rules of aesthetic principles divided into two types: universal design rules and distinctive style rules. These rules may be applied to a wide range of layout scenarios to produce functional, universally-accepted, aesthetically-pleasing designs. The framework also may allow for the personalization of these rules for a specific layout scenario to produce layouts with a distinctive look and feel.

The layout framework may incorporate various classes of layout algorithms, and, in one aspect, may automatically choose the appropriate algorithm based on the types of high-level layout constraints specified by the designer and/or user. Any appropriate heuristic technique, either alone or in combination, may be used to facilitate the optimization of a layout. One example of a flexible way to formulate the automated layout problem is as a set of constraints and an objective function. Hard constraints may be used to restrict the set of possible solutions, and the objective function may be used to measure the quality of a possible solution. The constraints and objectives may be applicable to a wide range of layout scenarios (e.g., keep objects inside page, don't overlap text, etc.), specific to a particular class of scenarios (e.g., keep labels close to their anchor in a labeled diagram, etc.), or specific to a particular type of element (e.g., restrict leader line angles to multiples of 45 degrees, etc.).

The objective function may be used to measure the degree to which a candidate solution adheres to the functional, design, and style rules. Objectives may be treated as penalty scores and the goal of optimization in this case is to minimize the objective function. One way in which the designer may stipulate those qualities that are the most important for the particular scenario is by assigning heavier weights to some objectives compared to others. For instance, functional rules may be given more weight than design rules or style rules.

Some layout problems can be posed as a search for an optimal layout over a space of possible layouts. One example of a general purpose layout algorithm suitable for use in the framework defines Initialize, Perturb and Score functions. The Initialize function serves to provide an initial arrangement of visual elements. The Score function assesses the quality of a layout based on the evaluation criteria. The Perturb function manipulates a given layout through a search space to produce a new layout within the search space. The search for an optimal layout may be performed by repeatedly perturbing and scoring the possible layouts until a termination condition is satisfied. In this example, the possible layout with the best score represents the possible layout that best adheres to the set of constraints. The search may be performed using any search technique including A*, tabu search, gradient descent, greedy algorithms, and simulated annealing, either alone or in combination. Non-search based techniques and artificial intelligence may be combined with the search-based techniques or utilized on their own to facilitate optimizing the layouts.

One type of layout algorithm suitable for use in the framework relates to grid-based geometry management. In such a technique, each visual element may be treated as content for a grid cell and constraints may be specified relative to other grid cells. Positional constraints may be used to specify the position of one cell with respect to another, while hierarchical constraints may be used to specify that one cell should appear within another cell. Initially, the entire page may form a single cell at the base of the hierarchy and all the other cells may be placed within it. Given a set of constraints specified in this grid-based manner, a geometry manager may expand the constraints from the top down to determine the absolute position of each grid cell.

Another type of algorithm suitable for use in the framework resolves systems of linear constraints. Each constraint may be specified as either a linear equation or an inequality, and each constraint equation may be given a priority so that higher priority constraints are resolved in favor of lower priority constraints if there is an inconsistency in the constraint system. By way of example, to translate higher-level constraints into a set of linear equations and inequalities, a user may enter a set of text rules using a grammar or through a graphical user interface, and the exemplary system may convert these into a set of low-level constraint equations which are fed into a backend constraint solver that generates the final layout. The solvers may apply linear programming in combination with constraint propagation in order to find the best solution to the system.

Another technique for resolving layout constraints relates to treating the visual elements as masses and specifying the constraints as forces acting on the masses. For example, the forces may be described using a spring model in which the force is proportional to the distance between the element center of mass and its desired position. Once a mass-spring system has been defined in this manner, standard physically-based constrained dynamics simulators may be used to find the rest positions, and hence the layout for the visual elements. The elements are placed in an initial position and the system is relaxed until it converges to an energy-minimizing state. The system may have an interactive user interface and be configured to simultaneously enforce layout constraints while allowing a user to drag, thereby allowing the user to interactively explore the configurations of the model consistent with the layout constraints.

A text layout engine may be used to build a representation similar to a mass-spring system. For instance, each word within a paragraph may be represented by a mass and the spaces between the words represented by springs. Using dynamic programming techniques, the goal of the exemplary layout engine is to determine the spacing between the words so that the line-breaks in the formatted text appear aesthetically pleasing.

As utilized herein, the term “Application Programming Interface” generally refers to a framework that includes a set of routines, protocols, definitions, functions, objects and other tools for building software applications. In relation to a framework, the term “general purpose” refers to the ability of the framework to be useful in the context of a range of applications, domains and scenarios. One such general purpose layout framework achieves this result by abstracting the lower-level layout algorithms into an API and by expanding the number and type of aesthetic objectives and visual elements operated on.

Exemplary embodiments of the system and methods are described with reference to the drawings, wherein like reference numerals are used to refer to like elements throughout. In the following description, for purposes of explanation, numerous specific details are set forth in order to provide a thorough understanding of the invention. It may be evident, however, that the invention may be practiced without these specific details. In other instances, well-known structures and devices are shown in block diagram form in order to facilitate describing the invention.

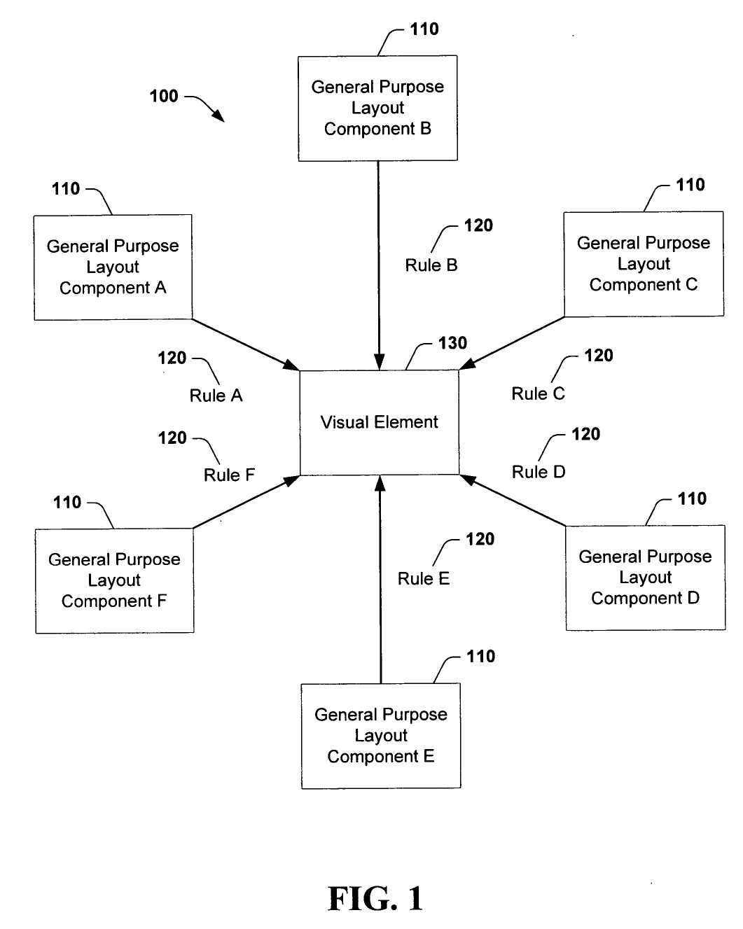

FIG. 1 illustrates a system 100 implemented according to one or more components of a general purpose adaptable framework 110 for optimizing visual content layout. The system 100 applies one or more rules 120 to at least one visual element 130 of the layout. The rules 120 may be functional, universal or style rules, for example, embodying functional or aesthetic design criteria, or combinations thereof. By applying the rules 120 to at least one visual element 130, the system 100 optimizes the layout in accordance with the rules.

Traditional approaches to automating layout are inflexible and domain-specific, requiring labor-intensive re-coding for each new application. One way in which the system 100 may improve automated layout is by abstracting the low-level algorithms into a general purpose adaptable layout framework and by providing an increased number and diversity of constraints and visual objects. By way of example, the framework may be implemented as a C++ Class library. Applications designers may personalize the classes to fit their particular domains. Through extending this class library, and using the many utility functions that already exist, applications developers very easily are able to get a new layout application coded. The framework may be enhanced by implementing a COM Interface to allow access from other languages (included managed code solutions), or a C# version.

The following description of functional and aesthetic principles embodied in the rules 120 is provided for illustrative purposes and is not intended to be limiting. These principles are indicative of but a few of the various ways in which the rules 120 may be employed.

Rules 120 may embody low-level functional principles that constrain those qualities of a layout that have the greatest impact on maintaining a clear and readable layout. Functional rules include but are not limited to overlap, proximity, and ordering. By way of example, if one element overlaps or occludes another, the two elements may cease to function as separate entities. This is most apparent with the overlap of text on text where complex letterforms become hopelessly intertwined rendering both text elements illegible. In a less extreme case, overlapping two shapes suggests a hierarchical association, in which the bottom element will appear to be the master of the top-most element. With regard to proximity, rules 120 may be used to maintain distances between two elements according to their relationship. For example, if one element describes another element, they may be kept in close proximity to each other, and other descriptive elements may be kept clearly away. Rules 120 also may dictate the ordering of elements on a page to imply relative importance and influence the viewing sequence. For example, functional rules may be used to keep the title of a figure near the top-left of the layout area so the viewer reads the title first.

Rules 120 also may embody high-level aesthetic principles that suggest the desired qualities of a layout such that their primary function is to improve the overall aesthetic quality. By way of example, the rules 120 may include universal design criteria that apply general knowledge of good layout practices derived from graphic design theory and Gestalt psychology. Exemplary universal design criteria include but are not limited to linear alignment, distribution, balance, proportion, color contrast, and continuity. These universal design rules may operate primarily as spatial organization techniques which, if applied individually or in combinations, help to achieve design and Gestalt principles.

The rules 120 may relate to arrangement or positioning of elements along a line or parallel lines to bring order and unity to a space. Linear alignment may be full, translational, or angular. Translational alignment is the arrangement of elements along an alignment line. Angular alignment rotates elements so their frame of reference is parallel to the alignment line. Full alignment is the combination of both translation and angular alignment. A formal definition of an alignment operation may include an alignment line and a frame of reference for each element. Alignment rules may be used to arrange elements to suggest larger shapes, implied lines, or dominant directional axis and to bring cohesion and unity to a layout. Many design and Gestalt principles can be entirely or partially achieved with alignment rules. By way of example, fundamental visual devices such as page margins, lines of type, and tables use alignment to organize their constituent elements in an orderly way.

Rules 120 relating to positioning elements evenly in space may be included in the system 100 to provide spatial organization and to establish an even rhythm among a set of elements 130. For instance, a line of fully justified text has the white space evenly distributed between words to make reading the line a rhythmic, consistent process. Positioning rules may be used to distribute elements 130 over a line, an area, or rotational sweep. When distributing over a line or area, the elements 130 may be positioned to achieve an equal amount of white space between them, or so that their corresponding frames of reference are at regular intervals. A rule 120 embodying a radial array may provide a special type of distribution in which each element's frame of reference angle is distributed evenly across a rotational sweep (i.e., a rotation from one angle to another). A formal definition of distribution may include a set of elements 130, each with a frame of reference, and a distribution space: a line, area, or rotational sweep. The distribution space may be defined to be the space between the minimum and maximum element in the set of elements 130 to be distributed.

Rules 120 relating to balance may arrange a set of elements 130 according to their size, color, or value to produce a state of visual equilibrium within a defined space. The visual balance may be symmetric, radial, or crystallographic. A formal definition of balance may be made in reference to a point (symmetric), a line (radial), or an area (crystallographic). A weight function may be used for the elements 130 to be balanced.

Rules 120 relating to proportion operate to position or manipulate elements 130 to create dominant features whose measurements adhere to a certain ratio. A definition of a proportion operation may include a target ratio, a function to obtain measurements from one or more elements 130, and a frame of reference for the measurement.

Rules 120 relating to contrast operate to position or manipulate elements 130 so that they can easily be seen when placed on a background (e.g., a textured surface or photographic image). A formal definition of contrast may include a function computing contrast between an element 130 and a background given the element's position within the background.

Rules 120 relating to continuity operate to position elements 130 in ways that suggest either visual connections or make clear delineations. A formal definition of continuity may include a function computing continuity between elements 130.

Rules 120 relating to a distinctive layout style emerge from the individual style of its elements 130. The framework may allow for distinctive style rules to be specified in a parameterized way so that a unique family of layouts can share a common, characteristic theme. The way in which visual attributes such as color, shape, or font are manipulated may be embodied as a style rule. For example, a rule may encourage text elements to assume a certain color when placed on an image background. The distinctive style rules may be personalized by a designer.

Visual elements 130 suitable for implementation in the system 100 include but are not limited to circles, pie slices, single lines, axis aligned text elements, multi-line text elements with justification support, multiple line segments, polygons, callouts, axis aligned rectangles, elements with no geometry of their own and defined by children elements, elements defining the fixed side of a callout, and elements allowing “snapping” behavior when exact alignment at a particular location is desirable.

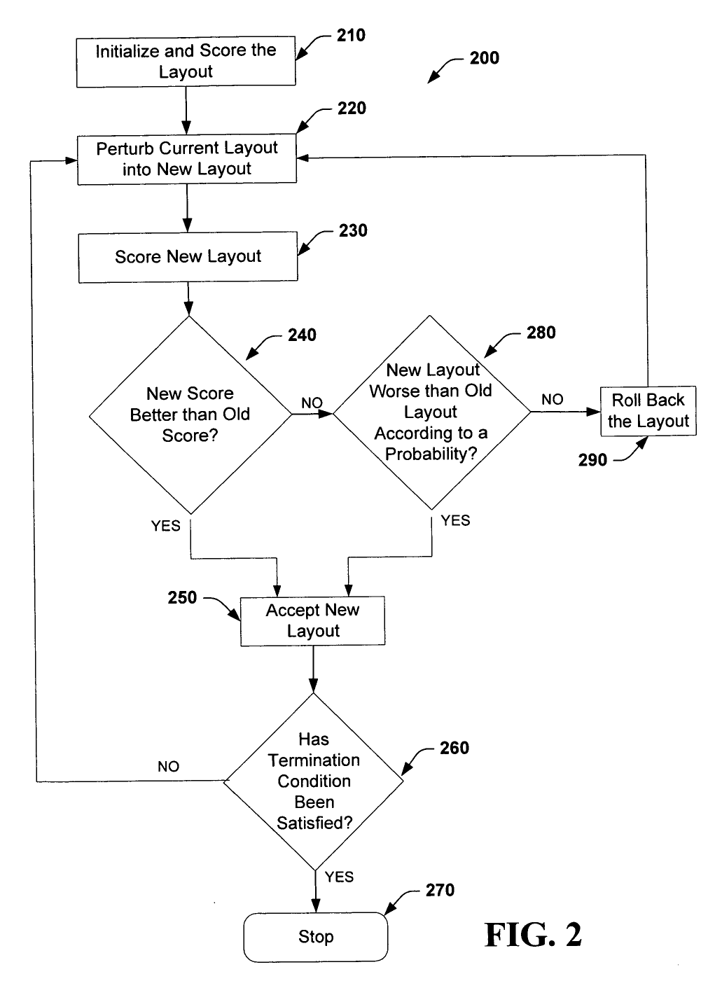

FIG. 2 illustrates a method 200 of employing a general purpose adjustable layout framework. A layout is initialized and scored at step 210. The current layout is then perturbed at step 220 and scored at step 230. At step 240, the new score is compared to the old score to determine if the new score is better. If the new score is better, the method proceeds to step 250 and the new layout is accepted. At step 260, a determination is made as to whether the termination condition has been satisfied. If yes, the method stops at step 270. If no, the method returns to step 220 and the current layout is perturbed and rescored at step 230. If at step 240 the new score is judged to be worse than the old score, the method proceeds to step 280 to determine whether to accept the worse layout according to a probability. If yes, the method proceeds to step 250 and the new layout is accepted. If no, the method proceeds to step 290 and the layout is rolled back. The method then proceeds to step 220 and the current layout is perturbed. The process continues until the termination condition is satisfied.

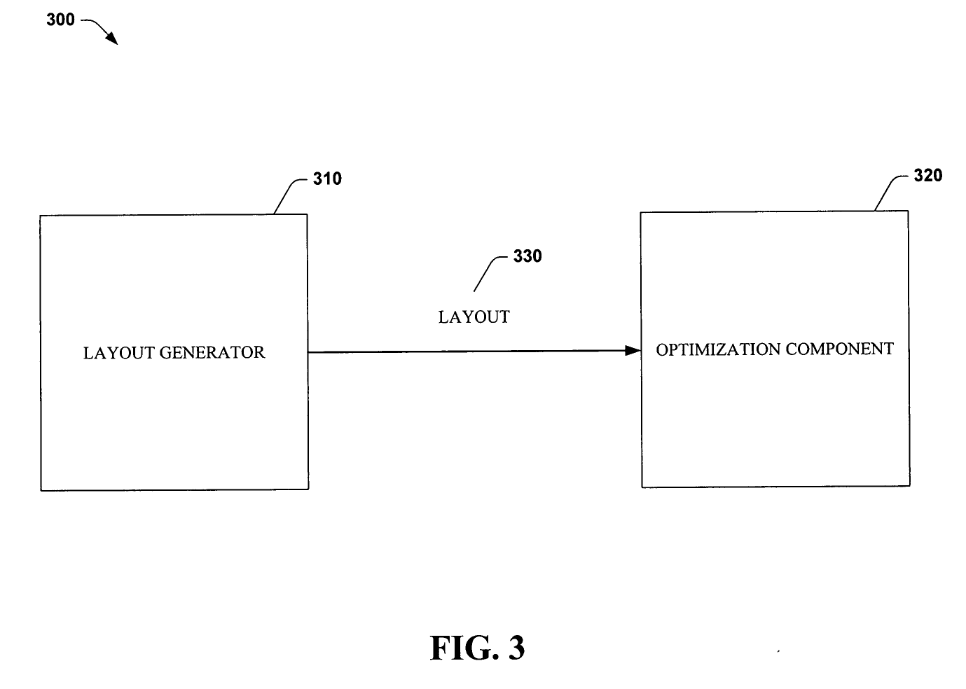

FIG. 3 illustrates a system 300 that enhances a layout utilizing the components of a layout framework adaptable to a plurality of applications. The system 300 has a layout generator 310 and an optimization component 320. The layout generator 310 provides a layout 330 to the optimization component 320. The optimization component 320 optimizes the layout 330 in relation to aesthetic principles.

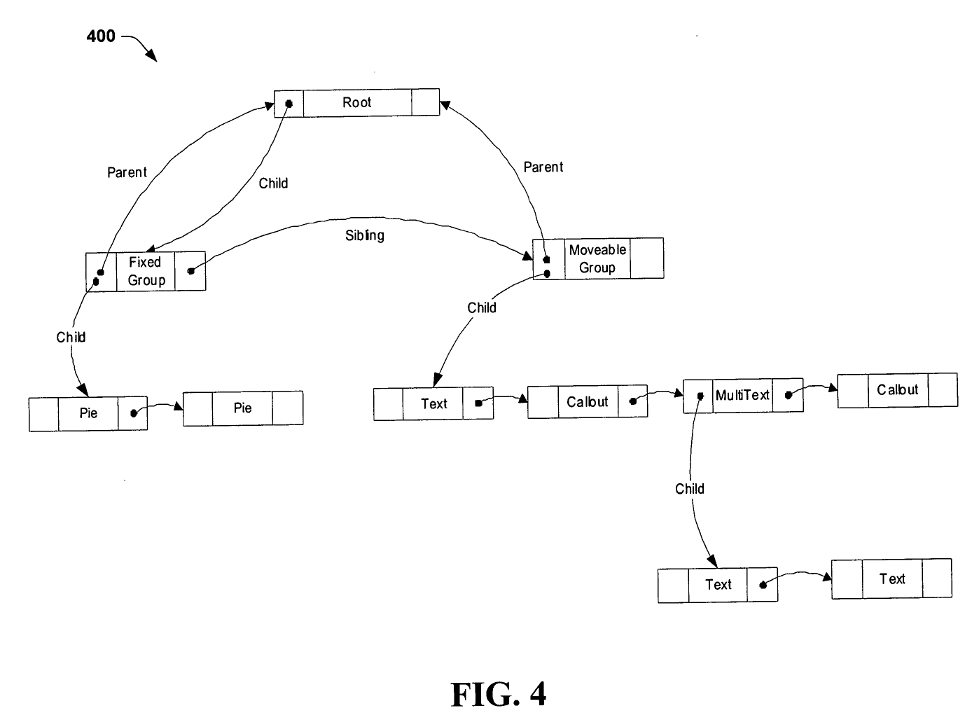

A layout 330 may be implemented by the layout generator 310 in part by a layout tree, which is an n-ary tree structure of elements. In one exemplary layout solution there are at least two classes of elements: fixed elements and moveable elements. The layout tree may represent these two classes of elements as two groups off the root—a fixed group and a moveable group. All fixed elements may occupy the fixed sub-tree and all moveable elements may occupy the moveable sub-tree. Other sub-trees off of the root may also exist, such as an alignment sub-tree, which may be used in some solutions to align moveable elements. Each node in the tree may contain three pointer to element “pel” pointers to support the tree structure: pelParent (parent of the node); pelChild (first child of the node); and pelSibling (sibling of the node). FIG. 4 shows an example of a layout tree 400. The parent links past the first level of the tree have been omitted for readability.

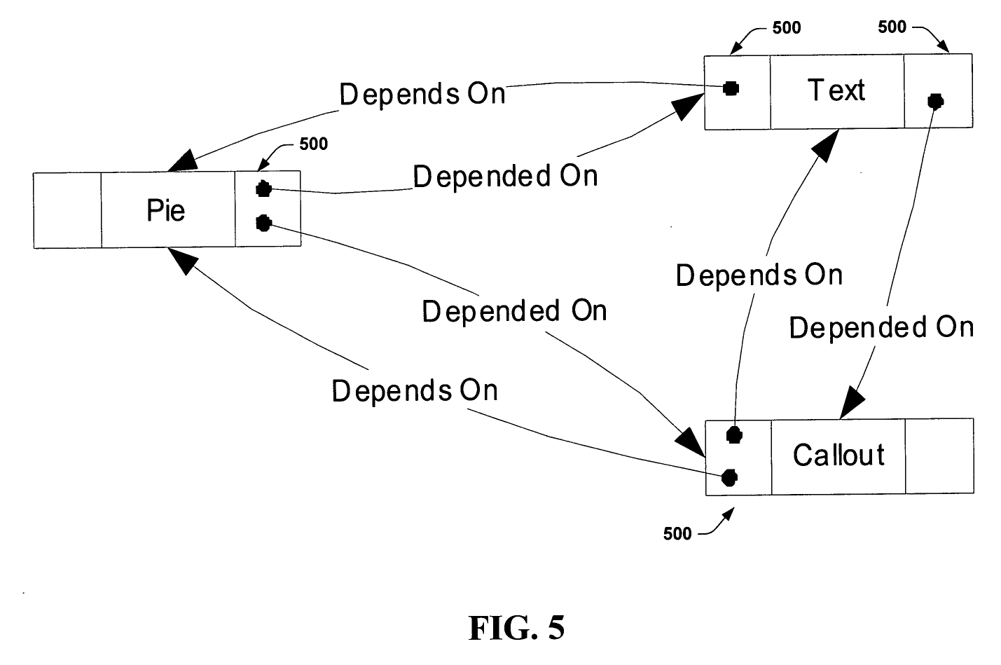

The layout generator 310 may specify dependency relationships between elements to facilitate generating a layout. By way of example, in certain labeling solutions, there is a moveable label that is intended to label a fixed element. The label is dependent on the fixed element since its position is determined by the location of the fixed element. In addition, it may be desirable to have a callout line drawn to connect the two elements if the distance between a label and the position being labeled is great enough. Because it connects the two separate elements, the callout is dependent on both the fixed element and the label element. One way a layout generator 310 may specify dependencies is to provide a variable-sized pointer array containing the dependency information in each element. FIG. 5 illustrates such a pointer array 500.

The optimization component 320 may use any suitable method to optimize the layout, for example, a search-based strategy such as simulated annealing. One implementation of a simulated annealing algorithm suitable for use in the system 300 is described by the following pseudo-code:

Procedure SimAnneal( )
1 InitializeLayout( )
2 E=ScoreLayout( )
3 while(! termination condition)
4 PerturbLayout( )
5 newE=ScoreLayout( )
6 if ((newE>E) and (Random( )<(1.0−e^{-ΔE/T})))
   7 RevertLayout( )
8 else
   9 E=newE
10 Decrease(T)

The InitializeLayout( ) function defines the initial placement for each of the visual elements and thereby provides a starting point for the search. The PerturbLayout( ) function provides a method for changing a given layout into a new layout, while the RevertLayout( ) functions inverts the actions of PerturbLayout( ) to go from the new layout back to the previous layout. The ScoreLayout( ) function computes how close to optimal the current layout is. Scores may be defined such that the lower the score the better the layout and, thus, the goal is to minimize the score. The process continues until one or more termination conditions are met. By way of example, suitable termination conditions may include:
1. Maximum number of iterations through the optimization loop;
2. Maximum number of iterations with no score improvement;
3. Minimum number of iterations since a bad move was taken; and
4. A certain amount of elapsed time has passed since the optimization started.

As shown in the pseudo-code, the simulated annealing algorithm accepts all good moves within the search space and, with a probability that is an exponential function of a temperature T, accepts some bad moves as well. This is determined by comparing a randomly generated number between 0 and 1 to the value of 1.0−e^{-ΔE/T}. If the random number is less than 1.0−e^{-ΔE/T}, the layout is rolled back. As the algorithm progresses, T is annealed (i.e., decreased), resulting in a decreasing probability of accepting bad moves. Accepting bad moves in this manner allows the algorithm to escape local minima in the score function.

In an exemplary system 300, there may be two types of scores: local scores and global scores. A local score relates to how a particular element and its dependent elements should be laid out in isolation. A global score relates to how well the whole model looks. The global score may be used to try to eliminate element overlaps, elements too close to each other, confusing element placement, etc. By way of example, the global score may be obtained by comparing each element in the tree with every other in the tree and getting distance and overlap scores for each pair of elements.

In one implementation of the system 300, constraints may be divided into two sets: 1) hard constraints that represent required characteristics of the layout (and which, therefore, bound the space of possible layouts); and 2) soft constraints that represent those characteristics desired in the final layout but not required in the particular application. Specifying too many constraints may over-constrain the problem and prevent robust generalization.

In one exemplary framework, hard constraints may be reflected in the InitializeLayout( ) and PerturbLayout( ) functions. The InitializeLayout( ) method provides the initial layout for an element. The PerturbLayout( ) method generates a new position for the moveable element taking into account all the hard constraints and may also re-generate all dependent objects' positions.

In one exemplary framework, soft constraints are the rules that allow the framework to determine whether one layout is better than another. The soft constraints may be embodied in the Score( ) function and are concerned with an element and its dependency graph. By way of example, the better a layout matches the optimal layout, the lower the score. A score may consist of many separate components. For example, if a callout exists or not, how far the label is from the object it is labeling, and many other components may determine a final score. Each component score may be normalized into the range [0-1] and a component weight may then be multiplied by the score to balance the component scores against each other.

A simulated annealing algorithm may be optimized in various ways. For instance, the better the PerturbLayout( ) function is, the sooner the search will converge to a near optimum solution. There are several ways to design a good PerturbLayout( ) function, such as by limiting the search area. The more the search area is constrained, the faster the method will converge on a good layout. By way of example, if the visual content is a pie chart layout, there is generally no value in searching beyond the extended pie slice as a position for a label. Although it would be good to allow some degree of freedom beyond the pie, it is unlikely that a label for a particular pie slice would be functional if it were on the other side of the pie.

Pre-computing a number of good candidate positions is another technique that may be used to speed the convergence. This may be done without respect to other moveable elements, but typically takes into account all fixed elements. Yet another technique that can be used is an adaptive search area. For example, if the visual content is a pie chart, the length of each label, the number of lines it contains, and the total number of labels may be used to determine the search area.

An optimization technique known as “differencing” entails taking an n² algorithm (checking every element against every other element in a model) and making it into a 2n algorithm on each iteration through the optimization loop. Instead of comparing each element to every other on each iteration, the score for a single element and its dependencies is computed before and after the perturb, and the difference is added in to the final score.

The speed of the annealing schedule may be varied to optimize a simulated annealing algorithm. For instance, if the termination condition is a time limitation, it is advantageous to get near the end of the annealing schedule before the time expires. If this does not occur and the iterations end early on in the annealing schedule, many random moves are likely to be still taking place, and the layout will be much less likely to be aesthetically-pleasing. To avoid this, the speed of the annealing schedule may be tuned.

Another technique to speed the algorithm is to include a small distance cache on each element to store the results from any expensive geometric calculations along with any special behavior flags that have been passed for later use. By way of example, data that goes through an object specific geometry routine and those elements that are within a prescribed distance of each other may be cached. Each cache entry and the elements may be time-stamped to reflect the time of a change. This facilitates a quick determination of cache element validity by comparing it to the two related elements' timestamps. The distance cache is more useful in situations in which there is a lower possibility of an undo or rollback. Typically, a large majority of the iterations in the optimization end in a rollback, and there is little utility in caching something that will be thrown out. The distance cache may also be turned off if the added space to hold the cache data is not worth the speed-up for a particular application.

Element lock-down entails locking down moveable elements that are in their best position and have little chance of inhibiting the movement of other elements. One example of this technique is a label inside a pie piece. Inside the pie piece is often considered the best location, and in this location, the label cannot interfere with any other label. In one implementation of the framework, elements that have shown no improvement in score after a specified number of iterations and are in known “good” places may be locked down. Elements in known “good” places immediately after initialization may be locked down, also.

Yet another technique to speed the process is a probability-based optimization. Probability based optimization entails optimizing the simulated annealing technique to assign a probability to each element based on its score. The higher the score, the higher the probability that the element will be moved.

A spatial data structure (such as a bin-tree) may be utilized to facilitate reducing the number of iterations required to check distances between elements. By way of example, for moveable elements in a pie chart, moveable labels farther away than 30° may not be checked since the probability of an overlap occurring is rather slim, though still possible in extreme cases. Rejection sampling and pre-computing the array are two techniques that may be employed to accomplish this task.

In general, the framework may avoid much unnecessary work by not computing the score for an entire model if the accumulated score is worse than the last score. That is, if the current iteration will not accept a bad move, then as soon as the cumulative score is larger than the previous score, the iteration is stopped. This technique speeds the process since most iterations end in a worse score and by using this technique, the iteration is cut short.

Partial optimizations may save overhead in those instances when a user has edited a portion of a layout. Partial optimization entails locking-down all elements that are not in the general proximity of the edit to the model. For example, if the text on a particular label in a pie chart is changed, just the edited label and those nearby would be re-laid out, and then only if the score change caused by the edit is not acceptable.

Simulated annealing is a non-deterministic algorithm. As such it is not likely that running the optimization twice will result in the exact same solution. Some methods to avoid “jumping layouts” include:
1. Only laying out the portion of the tree that has changed;
2. Since a random generator may be used to determine layout changes, saving off the initial random number seed can make identical models layout the same each time. The seed may also be derived from the actual data; and
3. Store off the positions of objects.

The following discussion provides a description of exemplary implementations of a general purpose layout framework applied across a variety of domain-specific applications. The examples provided are not intended to be limiting.

In one example, the framework may be utilized to solve a general labeling layout problem. In this example, the problem may be stated as determining how to effectively arrange and render an associated label element and an anchor element. The problem may be characterized as follows:
1) an anchor is a set of points (“anchor points”) and/or a set of polygons (“anchor regions”) indicating what is being labeled;
2) a label is the descriptive information, usually text, associated with an anchor;
3) A leader line is used to connect a label to its anchor when their distance is greater than some threshold; and
4) a figure is a matted image with an associated polygon (the clipping path of the matte) defining the boundary of the image's silhouette or some division of the silhouette;
5) The layout area is the available space where elements may be placed.

In this example, overlap and proximity objectives may be used to implement functional rules. Heavily weighted objectives may be used to keep elements (E) from overlapping each other and to remain at least a minimum distance apart. One function for these parameters is:

$$score ( {E}_{i} , {E}_{j} ) = \{ \begin{matrix}( ( 1 - R 1 ) + {R}_{1} O ) * {W}_{overlap} & if d < 0 \\ ( 1 - {R}_{2} ) d * {W}_{overlap} & o . w .\end{matrix}$$

where d is the shortest distance between Eᵢ and Eⱼ and O is some measure of overlap between Eᵢ and Eⱼ. By convention, if d is less than zero, then Eᵢ and Eⱼ overlap. R₁ and R₂ are constant weights for distance versus overlap in this combined objective. Other functions may also be used:

$$score ( {E}_{i} , {E}_{j} ) = \{ \begin{matrix}O * {W}_{overlap} & if d < 0 \\ \frac{{d}_{threshold} - d}{{d}_{threshold}} * {W}_{dist} & if d < {d}_{threshold} \\ zero ( 0 ) & o . w .\end{matrix}$$

where d is the shortest distance between Eᵢ and Eⱼ, O is some measure of overlap between Eᵢ and Eⱼ, Wₒᵥₑᵣₗₐₚ and W_{dist} are the weights in this combined objective, and d_{threshold} is the threshold distance beyond which there will be no change in the scoring function. This threshold distance is useful in optimizing the scoring function implementation.

Two specialized proximity objectives also may be used to evaluate a leader line's end point position within an anchor region and its length. The end position of the leader line may be penalized relative to its distance from the center of the anchor region according to the function:

$$score ( LL , A ) = \frac{‖ {P}_{end} - {P}_{center} ‖}{max ( w , h ) / 2} * {W}_{centered}$$

where P_{end} is the end point of the leader line, P_{center} is the center of the anchor region, and w and h are the width and height of the anchor region. W_{centered} is the weight of the objective. An exemplary leader line length objective is:

$$score ( LL ) = \frac{{l}_{main}}{{l}_{max}} * {W}_{length}$$

where lₘₐᵢₙ is the length of the main leader line segment, lₘₐₓ is an approximate upper bound and W_{length} is the weight of the objective.

The effective placement of text on images may require a combination of both contrast and continuity rules. In this example, two objectives are used to maximize the legibility of text T placed on an image I in those instances when legibility is affected by both the amount of contrast between the color of the text and the color of the image, as well as the continuity of the text with the form of the image under the text. Together these objectives score the legibility of T on I at position (x,y). An exemplary first objective may be based on the average difference in luminance between T and the luminance of I under T:

$$score ( T , I ) = 1 - ( {{avg}_{u = x … x + w}}_{v = y … y + h} [ lum ( T ) - lum ( I ( u , v ) ) ] ) * {W}_{contrast}$$

where w is the width of the text, h is the height of the text, lum(X) is the luminance of an element or pixel ranging between 0 and 1 and W_{contrast} is a constant weight. This objective assumes T has a single luminance, but the objective may be modified to allow individual words or characters of T to have different values. With this objective, note that if lum(I(u,v))≈0.5, then lum(T)≈0.0 [symbol] 1.0 will score equally well, even though in reality lum(T)≈1.0 may be more legible. To remedy this situation, contrast may be weighted to match empirical results from perceptual psychology.

An exemplary second objective may use the gradient magnitude of the image as a measure of the image's form. Text is essentially a collection of edges, and as such, placing text on an image area which also has many small edges is likely to produce continuities between the text T and image I making it illegible. Placing text at a location where there are few edges in the image will increase legibility. Thus, in this example, the continuity objective is simply a measure of the average gradient magnitude under T:

$$score ( T , I ) = {{avg}_{u = x … x + w}}_{v = y … y + h} [ ∇ ( I ( u , v ) ) ] * {W}_{continuity}$$

Where ∇(I(u,v)) is the gradient magnitude of I at pixel (u,v) and W_{continuity} is a constant weight. The text's perturb function probabilistically chooses to either select a new color or new position.

Long text labels may require techniques to handle line wrapping and justification, and objectives to encourage aesthetic alignment, wrapping, and proportion. In this example, a text block, T is composed of an ordered list of n words, w₁w₂ . . . wₙ and an ordered list of m lines, l₁l₂ . . . lₘ such that the length of each line is less than a desired width, d. The position of each line relative to T's frame of reference is dependent on the text block's horizontal justification, Hε{left, right, center, full}, and vertical alignment, Vε{top, bottom, middle}.

Text labels may have their width perturbed, which re-wraps the list of lines and changes the attachment point function, al(x). For instance, if there is only a single line, al(x) may only have 2 valid indexes for x corresponding to the left and right side of the text block. However, if there are 2 or more lines, al(x) may have 4 valid indices corresponding to top-left, top-right, bottom-left, and bottom-right. The applications designer may specify which alignment points are returned and which indexes are valid to achieve a certain style. Another way in which to accomplish aesthetic text-wrapping is by comparing the overall text block proportion against an ideal proportion (such as the golden section), and comparing the relative lengths of the lines in T after being wrapped to ensure that the wrapping is balanced.

An alignment group, A, is a set of elements constrained so their frame of reference origin remains on an alignment line. Each “align-able” element is referred to as Eᵢ, and the index of an element's possible frame of references is Fₖ. In one example, the framework may allow elements to be a member of no more than one alignment group. An exemplary alignment group A may position all of its member elements using a common frame of reference index, b. Each alignment group may have a perpendicular and parallel snap threshold, Tₚₑᵣₚ and Tₚₐᵣ, which determine the area in which new elements can be added to the group. The orientation of the alignment line in A is defined by a direction vector, d.

In this example, opportunities for creating an alignment group may be examined after an element, Eₚ, is perturbed. First, Eₚ is tested against all existing alignment groups, and added to the closest alignment group if Eₚ is within the snap thresholds. If no such alignment group is found, the closest non-aligned element is found which lies within the snap thresholds of a prototype alignment group positioned at Eₚ's frame of reference F_{b}. A prototype alignment group is an abstract alignment group defined only by a direction vector, frame-of-reference index, and snap thresholds. Each prototype alignment group represents a possible alignment orientation and direction.

Adding an element to an alignment group may involve snapping it along a vector perpendicular to the alignment line, and removing its perturb function from the system. By adding and removing perturb functions, the hard constraints and objective function are changed during the optimization. This can have the effect of changing the solution space temporarily so the search algorithm will favor optimal solutions which maintain these temporary constraints. Such constraints are referred to as variable constraints, i.e., hard constraints that are dynamically added and removed during the search process.

Once formed, an alignment group may perturb the position of the alignment line, the position of the member elements along the line, or the membership of the elements. One of these perturbs is chosen at a time over a discrete probability distribution. Perturbing the position of the alignment line also translates all member elements so they may remain fixed on the line. Alignment lines may be translated perpendicular to their direction vector, d. The second type of perturb moves an element along the direction vector of the line. This allows elements to find the optimal position along the line while staying aligned. Finally, the third type of perturb selects an element for removal from the alignment group. This prevents the system from being trapped too easily in local minima.

Since multiple groups may be formed from the same prototype alignment group, similar groups may be allowed to merge. In this example, the framework looks for merging opportunities after an alignment group, Aₚ, has perturbed its position. The position of Aₚ is compared to other similar groups using the same snap thresholds used for adding elements. If a similar group is found within the thresholds, Aₚ's elements are removed from Aₚ and added (snapped), to the found group.

In this example, translation alignment may be implemented as a variable constraint or quantified and optimized. To quantify the amount of alignment in the layout and the quality of group alignment, an objective score may be based on the proportion of aligned elements:
score=((N−N_{aligned})/N)*W_{aligned}
where N is the number of align-able elements and N_{aligned} is the number of elements which are members of alignment groups. W_{aligned} is a predefined constant which controls the weight of this exemplary score in relation to other objective scores.

The quality of group alignment may be influenced both by simple factors, such as the number of members, and by more complex interrelationships with other elements and alignment groups. By examining results from the variable constraint-only version of alignment, undesirable qualities may be identified. Such undesirable qualities include, for example, interleaving of alignment lines, alignment lines intersecting with the figure, line directions perpendicular to the figure, and the frame-of-reference on the wrong side of the figure. Objectives may be designed to discourage these undesirable situations from occurring.

In another example, leader lines may be created by manipulating shape. A leader line style may be defined by: a label attachment function al(x), where x is an index of available attachment points on the label; a length L for the first segment, called the extension; and a set A of preferred angles for the second segment. Length L may be set to a constant value to guarantee consistent leader line extension lengths, and al(x) may be constrained to include only attachment points deemed suitable for the intended style. Adherence to preferred angles is accomplished using a combination of a weighted-random perturb and an objective function.

By way of example, the quality of the leader line's angle may be scored using three objectives, the first of which is its exit angle from an outer figure:
score(LL,Fig)=1−|\hat{v}ᵤ·\hat{v}_{fig}^{⊥}|*Wₑₓᵢₜ
where \hat{v}ᵤ is the normalized direction vector of the main leader line segment, \hat{v}_{fig}^{⊥} is the normalized vector perpendicular to the segment on the outer figure through which the leader line exits, and Wₑₓᵢₜ is the weight of the objective function. This style serves to encourage leader lines to be perpendicular with the outer figure.

To penalize acute leader-line angles relative to the extension point, the following exemplary objective may be used:

$$score ( LL ) = \{ \begin{matrix}\vert {\hat{v}}_{s 1} \cdot {\hat{v}}_{s 2} \vert * {W}_{acute} & if {\hat{v}}_{s 1} \cdot {\hat{v}}_{s 2} > 0 \\ 0 & o . w .\end{matrix}$$

where \hat{v}ₛ₁ and \hat{v}ₛ₂ are the normalized vectors for the first and second segment of the leader line and W_{acute} is the weight of the objective.

The third objective penalizes leader line angles which deviate from the preferred angles in A, where the set A is defined to be all multiples of a:

$$score ( LL ) = 1 - \vert ( \frac{2 \vert Θ mod a \vert}{a} - 1 ) \vert * {W}_{preferred}$$

where theta is the angle of the leader line relative to the vertical and W_{preferred} is the weight of the objective function.

In this particular implementation, the leader line is dependent on the label's size and position. Although this allows the free perturbing and snapping of aligned labels, this dependency also may create situations where, given the location of the anchor, no leader line can be drawn using a preferred angle. Thus, a leader line perturb which favors angles in A, but will select an angle not in A if necessary may be used.

In this example, the perturb function of the leader line may be implemented to attempt to select a preferred angle first. For every possible attachment point al(x), a leader line extension is drawn with length L pointing away from the label. From the end point of each extension, rays may be cast along every preferred angle in A. Each of these rays may be tested for intersection with the target anchor region and with the label. If a ray intersects the anchor but not the label, then it may be saved in a list of candidate leader lines. After all rays are tested, one leader line may be chosen randomly from the list of candidates. During each ray intersection test with the anchor, two points may be saved: the entry point, P₁ and the exit point P₂. Using these points, the leader line endpoint, E, may be placed at E=P₁+\hat{r}[max((P₂−P₁)/2,Lₘₐₓ)] where \hat{r} is the unit direction vector of the ray, and Lₘₐₓ is constant defining the maximum penetration length of leader lines into anchors

If no candidate leader lines are found with preferred angles, a random line may be drawn from a random extension endpoint to a random point located inside the anchor. This facilitates assuring that a leader line will always be drawn.

The general purpose layout framework is adaptable across a variety of domains. One such scenario is to achieve sparse diagram labeling for localization. This diagram labeling scenario is composed of a small set of short labels anchored to a central illustration. A diagram is considered sparse if the combined area of all text labels is much less than the white space area surrounding the central illustration. Since there are many equally good positions for labels, higher-level aesthetic principles may be applied to bring order to the label positions within the overall layout.

In this example, linear alignment design rules may be employed to facilitating bringing order to how labels are positioned in sparsely filled white space. One way to accomplish this is to specify three prototype alignment groups: horizontal-bottom, vertical-left, and vertical-right. Snap thresholds may be based on the average length of labels. In addition to alignment, a leader line style may be implemented to create angles and maintain an extension length.

Translating labels to different languages often results in a wide range of label lengths, making it impossible to pick a single layout appropriate for all languages. Creating diagram layouts for every language is a time consuming task, particularly if the diagrams need to adhere to a certain design style. The adaptable layout framework may be utilized to automate this task by employing the diagram labeling and text wrapping functionality described above.

The multi-purpose framework may be adjusted to achieve dense central diagram labeling for varied display device sizes. This scenario includes a central image with surrounding dense and long text labels. The figure and labels are fit into different layout areas. The different layout areas vary according to the page size supported by various devices or display formats. The dense diagram condition indicates that there are many larger-sized labels, with from about 15 to about 30 words, occupying a large percentage of the available white space around the central image. The layout framework may be adapted to apply aesthetic principles so that different-sized diagrams have a consistent look and feel across devices, while keeping the central image as large as possible.

In this example, the style rules for leader lines may be simplified and more possible attachment points may be provided to simplify the problem as necessary. To address the problems of overlap and crossing leader lines in this application, a very long and slow anneal may be conducted, the label perturb may be refined, and labels may be allowed to shorten themselves to include a title only, or to drop their leader line if the anchor they are labeling is large enough and close enough. Another solution is to find the minimum distance from a point on the central figure to the closest label and use this to determine the maximum increase in size for the central figure.

The framework may be used for photo labeling and text-on-image placement. Placing text on an image is a common problem in many layout scenarios like photo labeling. One scenario consists of a single photographic background image with anchor regions to be labeled. The layout area matches the extents of the photograph, and, in this example, all labels must be placed on the image. Labels may be constrained to not overlap the anchors. For very dense photographs, an automatic label legend may be implemented as part of the optimization. This facilitates the label's perturb to remove the label text from the photograph and replace it with a short reference like “(a)”. The full label text may then be displayed in a legend.

Another application of this technique is to label products shown in photographs for use in catalog layout. This expands the photo labeling scenario to include more variety in label elements and varying text sizes. Heavily weighted objectives may be used to prevent overlapping labels, and lighter weights for objectives to find the best label placement considering the anchor location and image contrast and continuity. Text color may be perturbed to be any value, or restricted to the extremes of luminance, white, or black as a way to reduce the dimensionality of the optimization. In the scenario in which a slightly textured area would be preferable to one with a strong edge, a score based on the variance as well as the mean, or a non-linear score based on the log of magnitude may be implemented.

The framework may be used to facilitate catalog layout scenarios involving the placement and manipulation of not only labels, but also the images being labeled. For instance, a catalog image may feature a label communicating product information, such as pricing and description, and an image showing a picture of the product. Depending on the format of the product image (matted or cropped), labels may be placed on the image, beside it, or a combination of both. Images may be grouped together based on some meaningful association (e.g., similar function or common accessories).

In the catalog example, these labels have implied connections without the benefit of explicit leader lines. By allowing both the image and the labels to move, the resulting layout solution may resemble a free-form collage, or a more aligned, regular layout, depending on which aesthetic principles are applied. This added flexibility allows a user to generate digital versions of catalogs that more closely match the layout and aesthetics of their printed catalogs.

The aesthetically-rich automated techniques provided by the framework may be adjusted to provide the layout of products in web content, e-commerce pages, or custom printed catalogs. From a merchandiser's point of view, a generic layout does not highlight featured products and promote a brand as well as a distinctively designed layout does. Thus, aesthetically-effective layout is an integral part of the selling process. Major retailers also produce multiple printed catalogs for localized markets and special occasions, which, if done manually, can be time consuming and expensive. Recent advances in variable data printing and publishing have opened up the catalog publishing industry to many of the personalization opportunities the internet offers. However, the current technology often requires the use of rigid document templates created by a designer that result in generic layouts and many problems if data does not quite fit as expected.

Potential objectives and perturb functions identified for this scenario include but are not limited to:
1) Keeping the scale of images consistent or allowing different scales based on importance;
2) Clustering, and z-depth stacking rules;
3) Label placement rules: alignment according to anchor location, top of image, bottom of image, or on smooth area of image; and
4) Alignment to create more ordered layout, distribution to create more free-form layout.

The framework also may be used to reflow annotations as the size and formatting of a document is changed. For example, a callout annotation in a text document may consist of a handwritten note in the document margin with a line connecting this note to an anchor in the text. As the document is edited, the position of the anchor may change and it may be desirable to reposition both the line and the note to be close to the anchor, while keeping the note readable and ensuring that the text is not overlapped. The framework allows a designer to express these constraints and automates the repositioning. The framework also may be used within a Common Annotation Framework (CAF) to provide automated layout features.

In another example, as notebooks and tablet PCs become casual reading devices for electronic content, tools for converting magazine quality page layouts into aesthetically-equivalent electronic pages will be desired. Shrinking the printed page layout to fit an electronic display screen while maintaining legibility is currently a time-consuming, manual design process. The framework may be used to facilitate the ability of magazine publishers to automate shrinking magazine content and generating rich, electronic content by providing tools to automatically redesign hard content for smaller electronic display screens. For example, current systems require that designers create a new, customized template for resizing each diagrammatic illustration in a magazine. In contrast, the framework may be implemented so that designers may specify layout constraints at a higher level than the templates and may specify a general set of constraints that can apply to a much wider range of document formats.

In yet another example, the framework may be used to facilitate the creation of group presentations. Templates are commonly used to set a consistent style for a set of slides. Converting slides from one template style to another usually causes layout problems and makes it difficult to combine slides that were originally created using different templates. When creating group presentations today, the group members must either decide on a template in advance or spend time later fixing all the formatting glitches that arise when the templates are combined. The framework provides the tools necessary to automatically generate good layouts when converting slides from one template to another.

The adaptable layout framework may be applied in a wide variety of other scenarios, for example, modular furniture, garden design, and user interface layout. By way of example, modular furniture systems have many different pieces which can be assembled into many different configurations. Exemplary constraints and parameters include available space, required storage space, available pieces, cost, and aesthetic parameters like height, color, and style. Garden design requires positioning plants together in a fixed space. Compatible plants may be placed near each other and placement may be according to appropriate soil conditions, amount of sunlight, average temperature and rainfall, and aesthetic parameters like color, blooming period, and shape. User interface layout is an area that has a compelling motivation for automated layout based on different device form factors, personal preferences, and usage patterns. The various components of the general-purpose layout framework may be adjusted accordingly to achieve the design goals of all of these diverse domains.

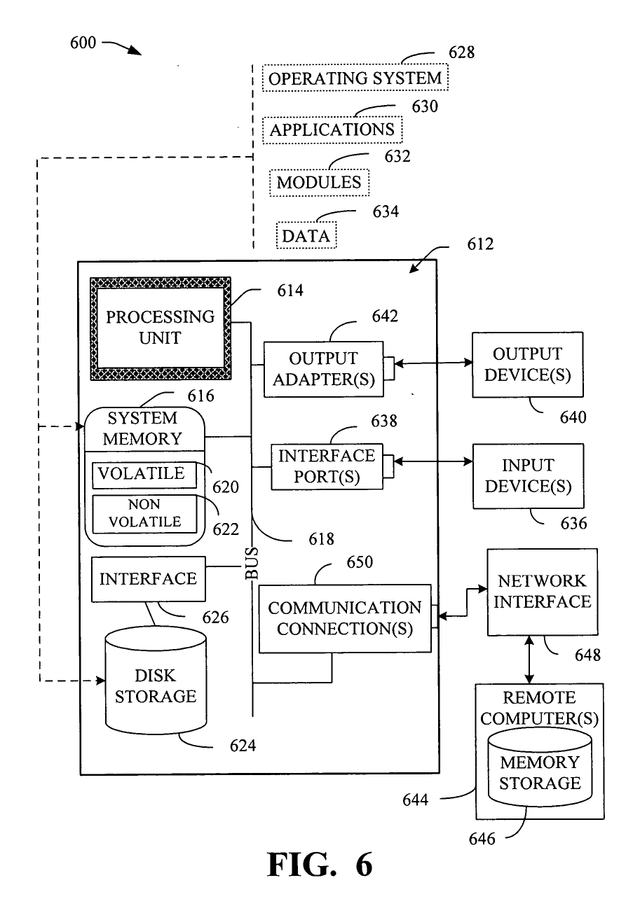

In order to provide additional context for implementing various aspects of the present invention, FIG. 6 and the following discussion is intended to provide a brief, general description of a suitable computing environment in which the various aspects of the present invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

With reference to FIG. 6, an exemplary environment 600 for implementing various aspects of the invention includes a computer 612. The computer 612 includes a processing unit 614, a system memory 616, and a system bus 618. The system bus 618 couples system components including, but not limited to, the system memory 616 to the processing unit 614. The processing unit 614 can be any of various available processors. Dual microprocessors and other multiprocessor architectures also can be employed as the processing unit 614.

The system bus 618 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 616 may include volatile memory 620 and nonvolatile memory 622. The basic input/output system (BIOS), containing the basic routines to transfer information between elements within the computer 612, such as during start-up, may be stored in nonvolatile memory 622. By way of illustration, and not limitation, nonvolatile memory 622 can include read only memory (ROM), programmable ROM (PROM), electrically programmable ROM (EPROM), electrically erasable ROM (EEPROM), or flash memory. Volatile memory 620 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 612 also includes removable/non-removable, volatile/non-volatile computer storage media. FIG. 6 illustrates, for example a disk storage 624. Disk storage 624 includes, but is not limited to, devices like a magnetic disk drive, floppy disk drive, tape drive, Jaz drive, Zip drive, LS-100 drive, flash memory card, or memory stick. In addition, disk storage 624 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 624 to the system bus 618, a removable or non-removable interface is typically used such as interface 626.

It is to be appreciated that FIG. 6 describes software that acts as an intermediary between users and the basic computer resources described in the suitable operating environment 600. Such software includes an operating system 628. Operating system 628, which can be stored on disk storage 624, acts to control and allocate resources of the computer system 612. System applications 630 take advantage of the management of resources by operating system 628 through program modules 632 and program data 634 stored either in system memory 616 or on disk storage 624. It is to be appreciated that the present invention can be implemented with various operating systems or combinations of operating systems.

A user enters commands or information into the computer 612 through input device(s) 636. Input devices 636 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 614 through the system bus 618 via interface port(s) 638. Interface port(s) 638 include, for example, a serial port, a parallel port, a game port, and a universal serial bus (USB). Output device(s) 640 use some of the same type of ports as input device(s) 636. Thus, for example, a USB port may be used to provide input to computer 612, and to output information from computer 612 to an output device 640. Output adapter 642 is provided to illustrate that there are some output devices 640 like monitors, speakers, and printers, among other output devices 640, which require special adapters. The output adapters 642 include, by way of illustration and not limitation, video and sound cards that provide a means of connection between the output device 640 and the system bus 618. It should be noted that other devices and/or systems of devices provide both input and output capabilities such as remote computer(s) 644.

Computer 612 can operate in a networked environment using logical connections to one or more remote computers, such as remote computer(s) 644. The remote computer(s) 644 can be a personal computer, a server, a router, a network PC, a workstation, a microprocessor based appliance, a peer device or other common network node and the like, and typically includes many or all of the elements described relative to computer 612. For purposes of brevity, only a memory storage device 646 is illustrated with remote computer(s) 644. Remote computer(s) 644 is logically connected to computer 612 through a network interface 648 and then physically connected via communication connection 650. Network interface 648 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 650 refers to the hardware/software employed to connect the network interface 648 to the bus 618. While communication connection 650 is shown for illustrative clarity inside computer 612, it can also be external to computer 612. The hardware/software necessary for connection to the network interface 648 includes, for exemplary purposes only, internal and external technologies such as, modems including regular telephone grade modems, cable modems and DSL modems, ISDN adapters, and Ethernet cards.

As utilized in this application, terms “component,” “system,” “engine,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

What has been described above includes examples of the invention. It is, of course, not possible to describe every conceivable combination of components or methodologies for purposes of describing the invention, but one of ordinary skill in the art may recognize that many further combinations and permutations of the invention are possible. Accordingly, the invention is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention and signals and data packets adapted to transmit such information, for instance, on a network.

In addition, while a particular feature of the invention may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A method of automatically enhancing a depiction, comprising:
quantifying at least one aesthetic quality of the depiction in relation to one or more non-mandatory objectives to produce a quantified aesthetic quality; and
automatically optimizing the quantified aesthetic quality to produce an enhanced depiction, wherein automatically optimizing the quantified aesthetic quality is performed utilizing one or more elements of a general purpose adaptable layout framework.

2. The method of claim 1 wherein the quantified aesthetic quality is automatically optimized utilizing simulated annealing techniques.

3. The method of claim 2 wherein the simulated annealing techniques are implemented to accept all good moves and accept some bad moves according to a probability.

4. The method of claim 1 wherein automatically optimizing the quantified aesthetic quality is implemented to avoid local minima.

5. The method of claim 1 wherein the general purpose adaptable layout framework is a general purpose layout API.

6. The method of claim 1 wherein the one or more non-mandatory objectives relate to one or more of linear alignment, translational alignment, angular alignment, full alignment, frames of reference, distribution, balance, proportion, color contrast, continuity, text wrapping, justification, text style, line style, labels, themes and Gestalt principles.

7. The method of claim 1 wherein the depiction is characterized by one or more visual elements relating to one or more of a circle, a pie slice, a single line, an axis aligned text element, a multi-line text element with justification support, multiple line segments, polygons, a callout, an axis aligned rectangle, an element defining the fixed side of a callout, and an element allowing snapping behavior when exact alignment at a particular location is desirable.

8. A depiction produced according to the method of claim 1.

9. Computer-executable instructions for performing the method of claim 1, the computer-executable instructions stored on computer-readable media.

10. A signal to be transmitted on a network, the signal carrying computer-executable instructions for performing the method of claim 1.

11. A method for improving an image, comprising:
invoking means for perturbing to perturb one or more elements of a layout of the image in accordance with one or more hard constraints to produce a current layout;
invoking means for scoring to assign a score to the current layout, the score reflecting adherence to one or more soft constraints;
accepting the current layout if the score indicates improvement in adherence to the one or more soft constraints;
reinvoking the means for perturbing and the means for scoring to operate on the current layout if the score does not indicate improvement unless a termination condition has been satisfied and terminating the method if the termination condition has been satisfied.

12. The method of claim 11 implemented by one or more layout APIs.

13. A system for identifying a desired arrangement of visual elements, comprising:
a set of general purpose layout components providing a framework for facilitating the automated arrangement of the visual elements according to a plurality of style rules, wherein the general purpose layout components are adjustable to a plurality of domains.

14. The system of claim 13 wherein at least one style rule is a universal design criteria.

15. The system of claim 13 wherein at least one style rule is derived from Gestalt principles.

16. The system of claim 13 wherein at least one style rule is specified by a user.

17. The system of claim 13 wherein the set of general purpose layout components is a set of general purpose layout APIs.

18. The system of claim 13 wherein the plurality of style rules relate to one or more of linear alignment, translational alignment, angular alignment, full alignment, frames of reference, distribution, balance, proportion, color contrast, continuity, text wrapping, justification, text style, line style, labels, themes and Gestalt principles.

19. The system of claim 13 wherein the components are distributed across a network.

20. Visual content produced by the system of claim 13.
